(19) United States
(12) Patent Application Publication
(10) Pub. No.: US 2020/0050692 A1
(43) Pub. Date: Feb. 13, 2020

(54) CONSISTENT READ QUERIES FROM A SECONDARY COMPUTE NODE

(71) Applicant: Microsoft Technology Licensing, LLC, Redmond, WA (US)

(72) Inventors: Panagiotis Antonopoulos, Redmond, WA (US); Chaitanya Sreenivas Ravella, Bellevue, WA (US); Yiqun Lin, Redmond, WA (US); Wei Chen, Sammamish, WA (US); Girish Mittur Venkataramanappa, Redmond, WA (US); Hanumantha Rao Kodavalla, Sammamish, WA (US)

(21) Appl. No.: 16/100,202

(22) Filed: Aug. 10, 2018

(51) Int. Cl. G06F 17/30

(52) U.S. Cl. CPC G06F 17/30371; G06F 17/30353; G06F 17/30327; G06F 17/30368; G06F 17/30315; G06F 17/30356

(57) ABSTRACT

Consistent read queries are enabled from a secondary compute node. In response to a read query, a page of data can be requested from a storage node with a first log sequence number indicating an update state of a local store of a compute node. The page of data can be received from the storage node with a second log sequence number indicating an update state of the page. Processing can be deferred until the first log sequence number is greater than or equal to the second log sequence number, wherein the first log sequence number is updated in response to automatic updates of the local store. A row of data can be retrieved from the page in accordance with the request. Further, a version of the row of data can be retrieved that has a timestamp equal to or before a timestamp associated with initiation of the read request.

### BACKGROUND

Databases are transactional systems that can provide certain guarantees, namely atomicity, consistency, isolation, and durability (known as ACID properties). Transactions are an action or series of actions that read or update contents of a database. For example, a transaction can be a money transfer that debits a first account and credits a second account. An atomic transaction is one in which all actions are performed or none of the actions are performed. Money is not debited from the first account without also crediting the second account. Consistency refers to a requirement that a transaction change data only in allowed ways to produce a new valid state from a prior valid state. For instance, money is not lost or gained. Isolation ensures transactions in process are isolated from each other. For example, the first account and the second account cannot be viewed until operations complete. Furthermore, changes are durable in that data remains in its correct state even in the event of failure or system restart.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to returning consistent results to read queries from a secondary compute node. Physical consistency associated with data structures can be maintained utilizing log sequence numbers and deferred processing. A comparison of log sequence numbers of two or more stores can be utilized to determine whether or not the stores are synchronized in terms of application of log records. When data stores are unsynchronized, processing can be delayed allowing time for a data store to catch up in terms of application of log records. Depending on the data structure involved re-traversal of the data structure may be required. Transactional consistency can also be maintained utilizing timestamps and versioned data. Timestamps can be employed to determine when a query is initiated, and versions of data can be located that existed at the time the read query was initiated.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the disclosed subject matter. Other advantages and novel features may become apparent from the following detailed description when considered in conjunction with the drawings.

### BRIEF DESCRIPTION OF THE DRAWINGS

FIG. 1 is a schematic block diagram of a distributed storage system.

FIG. 2 is a schematic block diagram of a consistency component.

FIG. 3 is a flow chart diagram of a method of read request processing.

FIG. 4 is a flow chart diagram of a method of processing a read request.

FIG. 5 is a flow chart diagram of a method of returning data from a storage node.

FIG. 6 is a flow chart diagram of a method of ensuring transactional consistency of a read query.

FIG. 7 is a flow chart diagram of a method of updating a data store.

FIG. 8 is a schematic block diagram illustrating a suitable operating environment for aspects of the subject disclosure.

### DETAILED DESCRIPTION

An architecture that separates query processing from storage can be employed to support large databases. Compute nodes can perform query processing separate from storage nodes that store data. A compute node can write changes to data in a log for access by storage nodes. Numerous storage nodes can be employed to store large amounts of data. For example, one hundred storage nodes can store one terabyte of data for a combined total of a hundred terabytes. Updates to data in storage nodes are made independent of other storage nodes by applying pertinent log records. In one implementation, compute functionality can be split between a primary compute node and a secondary compute node, wherein the primary compute node processes write queries and the secondary compute node processes read queries. Further, the secondary compute node can maintain a local store of data for expeditious response to read queries and apply log records to update data in its local store. The storage nodes and the local store of a secondary compute node can update their data asynchronously. The lack of synchronization amongst stores can result in inconsistency in the results of read queries. Furthermore, inconsistency can result from changes that occur to data during the processing of a read query.

The subject description pertains to returning consistent results to read queries from secondary compute nodes. Physical and transactional consistency can be maintained. With respect to physical consistency, a log sequence number can be employed as a measure of time associated with an update state. A compute node processing a read query can compare update state of the local store with a page of data received from a storage node by way of log sequence numbers to determine whether or not they are synchronized. If the local store and page of data are at different update states, processing can be deferred until they are synchronized. In some instances, a data structure may need to be re-traversed to locate a page relevant to a query. In addition to attending to consistent physical access to a data source, transactional consistency can be addressed by way of versioning. Here, timestamps can be employed to determine when a query is initiated, and versions of data can be located that occur at that time or before. For instance, data versions can be traversed to locate a version of data that existed at the time the read query was initiated.

Various aspects of the subject disclosure are now described in more detail with reference to the annexed drawings, wherein like numerals generally refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

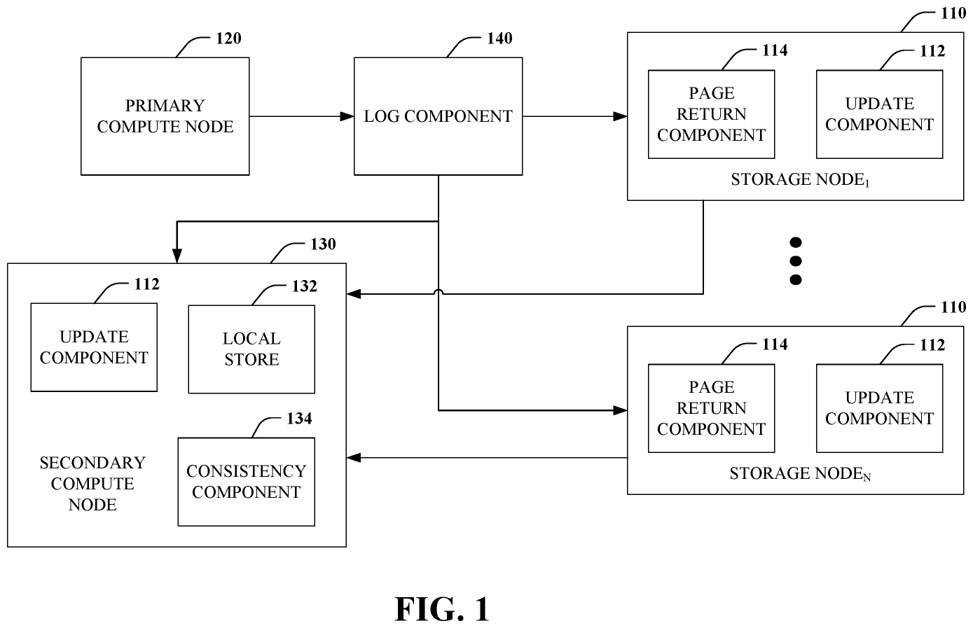

Referring initially to FIG. 1, a distributed storage system 100 is illustrated that separates query processing from storage. The distributed storage system includes a number of storage nodes 110 (STORAGE NODE₁-STORAGE NODE_{N}, where “N” is an integer greater than one) that store user data. Together the storage nodes 110 can enable storage of large amounts of data (e.g. 100 terabytes or more). In addition to storage capability, the storage nodes 110 include an update component 112 and a page return component 114. The update component 112 is a mechanism that updates data as specified with write queries (e.g., insert, delete, modify). In one instance, the update component 112 can access a shared log and update corresponding data in accordance with transaction records of the log. Each log record can be associated with a log sequence number, which is a monotonically increasing number that indicates a specific state. Further, the log sequence numbers can be saved with respect to a data source as an indicator of update state. Each storage node 110 can operate independently and without coordination with other storage nodes 110. Accordingly, rates of update can vary. The page return component 114 is a mechanism for responding to requests for data. In accordance with one embodiment, the page return component 114 can receive a request for a page of data and a log sequence number that provides a measure of time or an update status. In response, the page return component 114 can return a requested page with a log sequence number greater than or equal to the log sequence number in the request.

The distributed storage system 100 also includes primary compute node 120, secondary compute node 130 and log component 140. The primary compute node 120 processes write query operations, such as insert, delete, and modify. Write-ahead logging can be employed with respect to the primary compute node 120 such that a modification is first written to a log prior to applying the modification to data. The log component 140 can maintain a transaction log that can be written to by the primary compute node 120 in accordance with write-ahead logging. Subsequently, each storage node 110 can access the transaction log by way of the log component 140 and apply changes applicable to that storage node with update component 112. The secondary compute node 130 is configured to process read queries. By sending read queries to a different node, the primary compute node 120 need only be available to process write queries, thereby scaling a workload and increasing performance.

The secondary compute node 130 includes local store 132 and update component 112. The local store 132 stores previously received data locally for subsequent expeditious acquisition without re-reading data from a storage node 110. In other words, the local store 132 is a cache for the secondary compute node 130, thereby minimizing latency cost associated with utilizing storage node 110. The local store 132 can be a computer-readable storage medium, including volatile or non-volatile storage. The update component 112 provides a means to update the local store 132. More specifically, the update component 112 can communicate with the log component 140 and determine whether any log records relate to the content of the local store 132. Log records related to the content of the local store 132 can then be applied to the local store 132 unless they were previously applied. Further and in accordance with one implementation, the local store 132 need not know the structure of a page, or other unit of data. Rather, the local store 132 can simply store pages of data, which can be from different structures (e.g., B-tree, heap, lob . . . ), and a runtime process can determine the type of structure from metadata while serving read queries.

The secondary compute node 130 also includes consistency component 134. The consistency component 134, alone or in combination with other components, can ensure that results of read requests processed by the secondary compute node 130 are consistent. When data is retrieved from storage nodes and added to the local store 132, the consistency component 134 ensures that solely consistent data is available for return. In one instance, the consistency component 134 provides a mechanism to maintain physical consistency in terms of access with respect to a particular data structure. In another instance, the consistency component 134 also provides a mechanism to maintain transactional consistency.

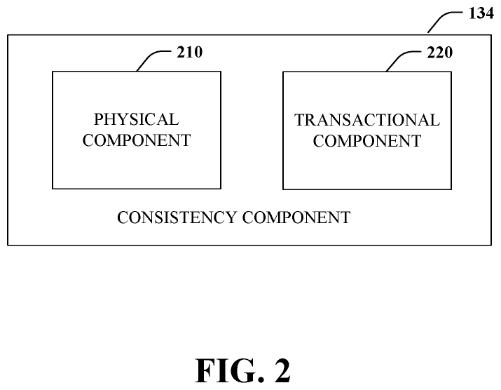

Turning attention to FIG. 2, the consistency component 134 is illustrated in further detail including physical component 210 and transactional component 220. The physical component 210 provides a means to ensure consistent read results from storage structures. Stated differently, the physical component 210 provides the secondary compute node 130 with a consistent view of database structures (e.g., b-trees, heaps . . . ) so that the secondary compute node 130 can traverse and eventually access user data to respond to a query. Log sequence numbers can be utilized as a measure of time or update state of a source of data directed toward ensuring consistent read results.

Log sequence numbers are monotonically increasing numbers associated with log records that are generated for each write operation to a page of data. Each page in a data store can be tagged with the log sequence number of the last log record that was applied to the page. For instance, the log sequence number associated with the local store 132 of the secondary compute node 130 identifies the last log record that has been applied to a page of data on the local store 132. Similarly, the log sequence number associated with a storage node 110 indicates the last log record that has been applied to a page of data on the storage node 110. Furthermore, the log sequence number of a particular page of data denotes the last log record that was applied to the page of data.

The consistency component 134 can compare log sequence number to reason about and direct processing based on update states. Data can be retrieved from one or more of the storage nodes 110, when the data is not already present in the local store 132 of the secondary compute node 130. In this case, the state of the data in the local store 132 can be compared to the state of a page of data acquired from at least one of the storage nodes 110 by way of log sequence numbers. If the log sequence numbers are the same, there is no physical consistency issue and the processing of a read query can proceed. If the log sequence numbers are different, there is a physical consistency issue that can be addressed. As previously noted, storage nodes 110 can be configured to return data with log sequence numbers equal to or greater than the local store 132. However, the log sequence number of the local store 132 can be less than the log sequence number of a page of data, or the storage node from which the data was acquired. Stated differently, the update state of the local store 132 lags behind that of a page of data received from a storage node 110. In this case, the physical component 210 can defer further processing until the update state of the local store 132 is the same as the page of data. Once the update component 112 updates the local store 132 to a state that is the same as the page of data, further processing can be initiated. In other words, a processing thread waits and is triggered to proceed once the update states are the same.

Implementation of the physical component 210 can vary based on the type of data structure employed. As a first example, consider heap and lob data structures. For heaps and lobs, once a row is placed on a particular page, the row will typically not be moved from that page. If a page of data has a log sequence number greater than the local store 132, any latch that is applied to a page can be released and further processing can be deferred until the local store 132 reaches the log sequence number of the page. More specifically, if a page “P” is not in the local store 132, page “P” can be requested from a storage node 110. If the page log sequence number is higher than the local store 132 log sequence number, a latch on the page “P” can be released and the process waits until the log sequence number of the local store 132 reaches the log sequence number of the page. After the wait is over, traversal simply continues where it left off.

As a second example, consider a B-tree, which is a self-balancing tree data structure that keeps data sorted and can have more than two children. Unlike heaps and lobs, B-tree rows can be moved to different pages. When the log sequence number of a page is higher than the local store 132, any latches that were previously set are released and a wait period is employed to allow the local store 132 to catch up to the page log sequence number. After the local store 132 reaches the page log sequence number, traversal of the B-tree can restart from the root. As an example, assume traversal is at the Nth level of a B-tree and the parent page “P5” has been latched. Following B-tree traversal, a child page “P10” can be identified and latched. If “P10” is present in the local store, the traversal can continue. If “P10” is not present in the local store 132, a request is made to a storage node 110. If the log sequence number of “P10” received from the storage node 110 is less than or equal to the local store 132, traversal can simply continue the traversal. If the log sequence number of “P10” received from the storage node 110 is greater than the local store 132, the latches on pages “P5” and “P10” are released. Subsequently, the process waits for the local store 132 to reach the page log sequence number of “P10” and then restarts traversal from the root. Once the page being sought is brought into the local store 132, it can be maintained with the update component 112 and available for future traversals. This process can repeat until the leaf node level of the tree is reached.

The transactional component 220 provides a means for ensuring transactionally consistent results from the secondary compute node 130. The transactional component 220 can utilize snapshot isolation in combination with versioning to ensure transactional consistency. Snapshot isolation guarantees that all reads made in a transaction will see a consistent snapshot of a database. In other words, transactions should read the data that was present when the transaction started. The transactional component 220 can record the start time of a read transaction and ensure the last committed values that existed at the start time are read. This can be accomplished by comparing a timestamp of the start time of the read transaction with the time stamps of versions of data elements, such as rows. By way of example, assume a transaction “T1” started at time “1” and read the row “R1.” Now assume another transaction “T2” started at time “2” and updated row “R1” to “R2.” When “T2” updates the row, it creates a new version for “R2,” retains the old version for “R1,” and makes “R2” point to “R1” thus creating a version chain. When transaction “T1” reads the same row again, the version chain can be traversed to show “R1”to “T1” since “R1” is the appropriate value of the row when “T1” started. Once the secondary compute node 130 reads a page from a storage node 110, the transactional component 220 can check if rows on the page are visible based on timestamp comparison to determine visibility. If the rows are not visible, the version chain can be traversed to locate the visible versions. While traversing the version chain, more pages from the storage nodes 110 may be requested as versions can be present on different pages. Once the old versions are no longer needed, they can be removed, for example by the primary compute node.

Returning attention to FIG. 1, the update component 112 of the secondary compute node 130 can apply log records generated by the primary compute node 120 to local store 132. In accordance with one embodiment, the update component 112 can employ parallel threads to improve log apply speed. Such a parallel update can affect how the consistency component 134 maintains physical consistency with respect to a B-tree structure. More specifically, a scan of the B-tree may need to be repositioned and traversal retried.

By way of example, assume a log sequence number of the local store is “100” when the parent page “P5” is latched. Now, while latching a child page, “P10” can be requested at log sequence number “100.” Assume the storage node returned the page “P10” at log sequence number “200.” Also, assume that there are changes to “P5” and “P10” between the log sequence numbers “100” and “200.” In single threaded log apply, the log apply can be blocked while attempting to apply the log on “P5” as the reader thread already latched “P5.” However, in a parallel case, solely the log apply thread corresponding to page “P5” is blocked and other parallel log apply threads continue to apply the log records. Consequently, the local storage log sequence number can continue to increase as log records are applied. It may be the case that the local store log sequence number reaches “200” by the time the request to the page “P10” is completed on the secondary compute node. In this case, even though local store log sequence number is equal to “P10” page log sequence number “200,” a scan reposition should occur because there are changes modifying “P5” and “P10” between the log sequence numbers “100” and “200,” and the parent “P5” could have been split between these log sequence numbers. The B-tree traversal might be invalid as a result. This can be detected by determining if there any pending log records for the page “P5” and if so, the scan can be repositioned, and the traversal retried.

FIG. 1 depicts a separation in query processing between the primary compute node 120 and the secondary compute node 130 in which the primary compute node 120 processes write queries and the secondary compute node 130 processes read queries. The subject system, however, is not limited to a single primary compute node 120 and secondary compute node 130. Rather, the system is configurable to support substantially any number of primary compute nodes 120 and secondary compute nodes 130. Further, functionality of the secondary compute node 130 can be added to the primary compute node 120 in an alternate system that does not separate processing between different compute nodes. Additionally, functionality performed by the storage nodes 110 in returning pages with a log sequence number greater than or equal to a requested log sequence number of the local store 132 can be incorporated into the secondary compute node 130. For example. log records can be cached or buffered by the secondary compute node 130 and used to create a data page with a particular log sequence number.

In accordance with an embodiment described above, physical consistency can be maintained by reasoning about the state of data stores based on log sequence numbers and where applicable waiting for stores to synchronize prior to continuing processing. In an alternative embodiment, a secondary compute node 130 can request a page of data at a specific time or update state. For example, a page can be requested with a log sequence number “T1.” In this embodiment, the storage nodes 110 would be responsible for maintaining pages at different points in time in order to be able to return a page at a designated time. In this case the alternate embodiment, may require a large amount of storage space to store multiple page versions. Alternatively, more memory or processing can be required to reconstruct another version of a page from the transaction log, for example. While these approaches may achieve the same or similar result, they are substantially more complex and more resource intensive than the embodiment described above. Stated differently, reasoning about the state of data stores based on log sequence numbers as well as performing wait and retry to synchronize data stores is a simpler and more efficient approach.

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, various portions of the disclosed systems above and methods below can include or employ artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example, and not limitation, predictions can be made regarding pages that are going to be needed and those pages can be pre-fetched. For instance, assume a row is to be read and it is known to be in the left most subtree, the leftmost subtree can be pre-fetched. Alternatively, based on knowledge that a user is frequently accessing a mid-layer of a tree or other data structure, pre-fetching can be performed to read ahead. Using machine learning, heuristics, or the like, actions can be taken ahead of time to minimize time spent waiting for updates as well as retrieving data from storage nodes.

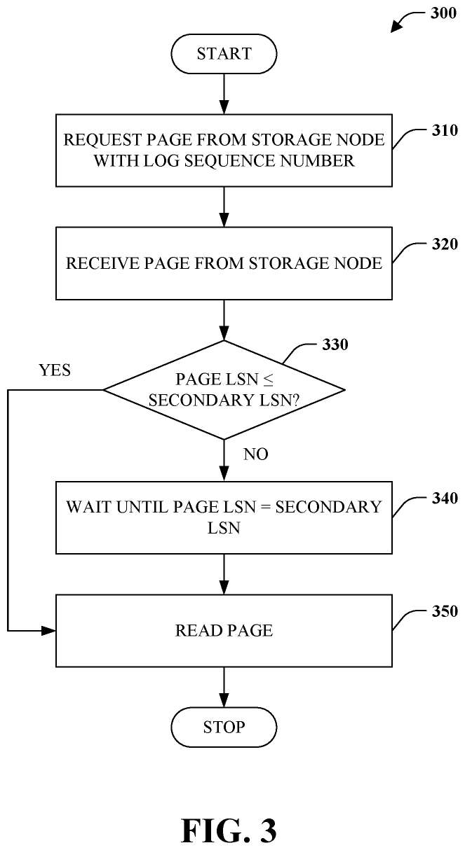

In view of the exemplary systems described above, methods that may be implemented in accordance with the disclosed subject matter will be better appreciated with reference to the flow charts of FIG. 3-7. While for purposes of simplicity of explanation, the methods are shown and described as a series of blocks, it is to be understood and appreciated that the disclosed subject matter is not limited by the order of the blocks, as some blocks may occur in different orders and/or concurrently with other blocks from what is depicted and described herein. Moreover, not all illustrated blocks may be required to implement the methods described hereinafter. Further, each block or combination of blocks can be implemented by computer program instructions that can be provided to a processor to produce a machine, such that the instructions executing on the processor create a means for implementing functions specified by a flow chart block.

FIG. 3 illustrates a method 300 of processing read requests with data from a storage node. In other words, at least a portion of data needed to satisfy a read request is stored in one or more storage nodes as opposed to already being present in the local store of a compute node. At reference numeral 310, a page is requested from a storage node together with a log sequence number. In other words, a request is submitted to a storage node, wherein the request comprises a page identifier and a log sequence number. The page can include data needed to process a read request. The log sequence number can be the number of the latest update applied to the local store of a secondary compute node responsible for processing the request. At numeral 320, a page is received from the storage node in response to the request. At numeral 330, a determination is made as to whether the page log sequence number (LSN) is less than or equal to the secondary compute node log sequence number (LSN), or more particularly, the local store of the secondary compute node. If the page LSN is less than or equal to the secondary compute node LSN (“YES”), meaning the page and the compute node are at the same or consistent update state, the method proceeds directly to reference numeral 350, where the page is read. If, at 330, the page LSN is not less than or equal to the secondary compute node LSN (“NO”), the method continues at numeral 340, wherein processing is deferred to wait for the secondary compute node to update such that the page LSN is equal to the secondary compute node LSN. Subsequently, the page is read at numeral 350.

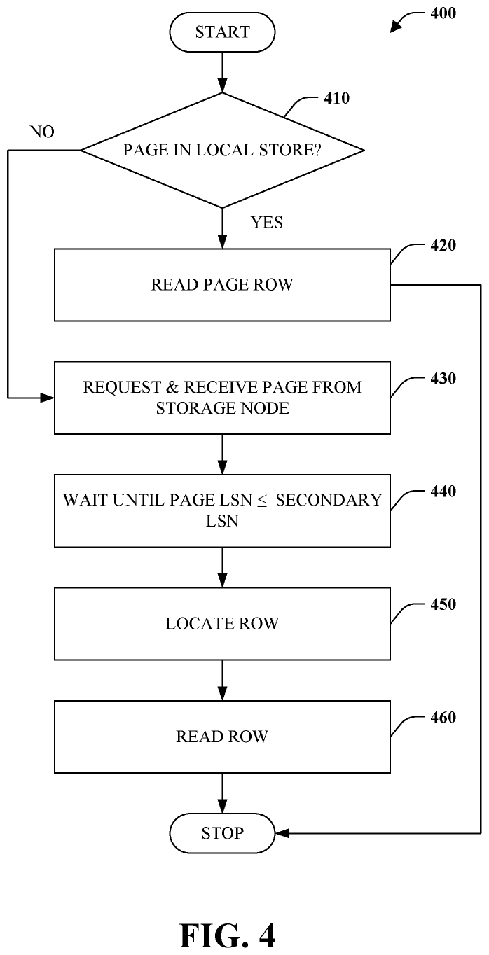

FIG. 4 depicts a method 400 of reading a page from local storage. At reference numeral 410, a determination is made as to whether a page required to satisfy a read request is in the local store. If the page is in the local store (“YES”), the method continues to numeral 420, wherein at least one row is read from the page. If the page is not in the local store (“NO”), the method proceeds to numeral 430. At numeral 430, the page is requested and received from a storage node. In one implementation, the page can be requested along with a minimum log sequence number (LSN), such that the page returned has log records applied at least up to the log sequence number. At numeral 440, a wait is performed until the page LSN is less than or equal to the secondary compute node LSN. In other words, processing is delayed until the secondary compute node LSN is at least caught up to the page LSN. If the LSN of the page initially returned is less than or equal to the secondary compute node LSN, the wait could be solely the time it takes to make this determination. If the page LSN is greater than the secondary compute node LSN, the wait can be the time it takes for the secondary compute node to be updated to the same LSN. At reference numeral 450, a relevant row is located. For heap and lob data structures, location of the row can be by way of direct access on the page since the row is typically fixed on the page. For structures such as B-trees, the row may be on a different page. Accordingly, location of the row can be performed by traversing the data structure from its root. At numeral 460, the located row can be read.

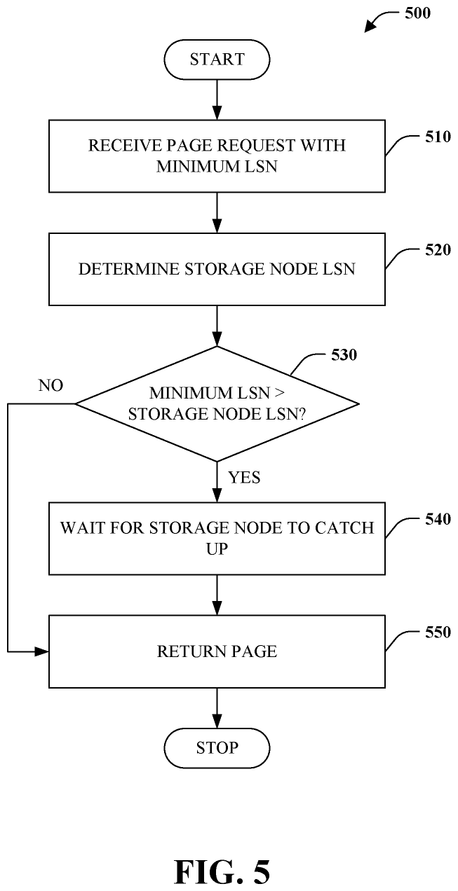

FIG. 5 illustrates a method 500 for returning a page of data from a storage node. At reference numeral 510, a request for a page is received together with a minimum log sequence number (LSN). For example, the minimum LSN can be the LSN of a secondary compute node. At numeral 520, the storage node LSN is determined. At reference numeral 530, a determination is made as to whether or not the minimum LSN is greater than the storage node LSN. If the minimum LSN is greater than the storage node LSN (“YES”), the method continues at 540. At 540, processing is deferred to wait for the storage node LSN to catch up to the minimum LSN by way of automatic application of log records. Once the storage node is caught up, the page can be returned at numeral 550. If, at reference numeral 530, the minimum LSN is not greater than the storage node LSN (“NO”), the method proceeds directly to numeral 540, where the page is returned in response to the request.

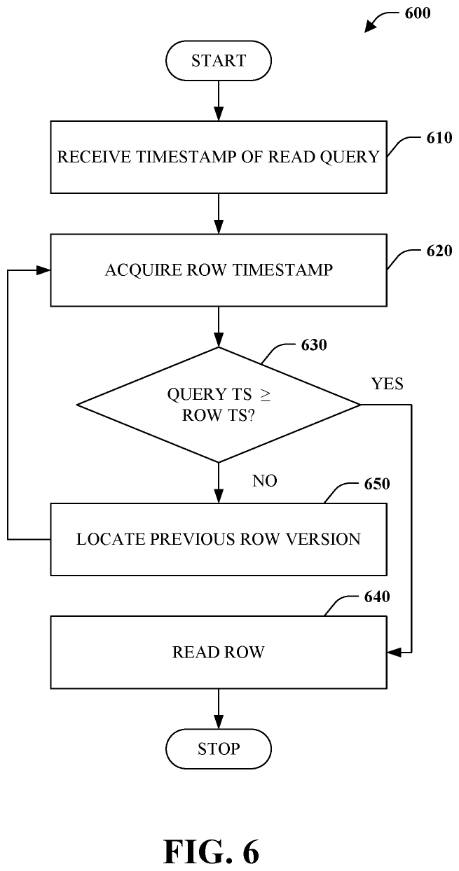

FIG. 6 depicts a method 600 of ensuring transactional consistency of a read query. At reference numeral 610, a timestamp is received associated with a read request, transaction, or query. The timestamp can indicate when processing of a read query begins or, in other words, the start time of processing a read query. At numeral 620, a row timestamp is acquired for a row to be read in accordance with the read query. At reference numeral 630, a determination is made as to whether the query timestamp is greater than or equal to the row timestamp. If the query timestamp is greater than or equal to the row timestamp (“YES”), the method proceeds directly to numeral 640, where the row is read. If the query timestamp is not greater than or equal to the row timestamp but rather the row timestamp is greater than the query timestamp (“NO”), the method continues at reference numeral 650. At reference numeral 650, a previous version of the row is located. For example, previous versions of data elements such as rows, can be linked in a chain (e.g., linked list) that can be traversed. The timestamp of the previous version of the row is then acquired at 620 and a comparison made between the query timestamp and the timestamp of the previous version of the row. The cycle can continue until the timestamp of the previous version of the row is less than or equal to the query timestamp.

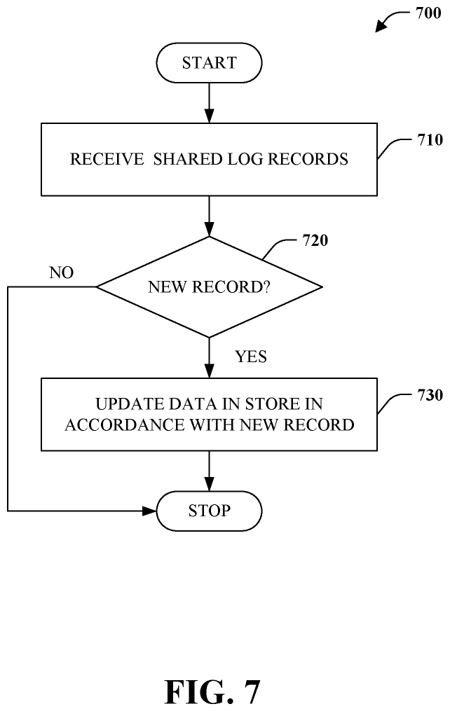

FIG. 7 is a flow chart diagram of a method 700 of updating a data store. The data store can be a local store of a secondary compute node or a storage node store, for example. At reference numeral 710, shared log records are received. For instance, a network accessible location separate from processing and storage nodes can be accessed to receive, retrieve, or otherwise obtain or acquire log records. At numeral 720, a determination is made as to whether or not a new record is present associated with a store and not applied yet. In accordance with one implementation, each log record can be assigned a unique monotonically increasing number, namely a log sequence number. If a data store that houses a data record subject to the log record has a log sequence number less than the log sequence number of a log record, this can indicate a new log record is applicable. If the data store has a log sequence number that is equal to or greater than the log sequence number of the log record, the data store is up-to-date. If, at 720, a new record applicable to a data store is detected (“YES”), the data store is updated in accordance with the new log record at reference numeral 730. If, at 720, a new record applicable to a data store is not detected (“NO”), the method simply terminates. The method 700 illustrates one iteration. Log records can be checked at predetermined times or periodically (e.g., every 2 minutes). Alternatively, a long running thread can continuously read log records and apply the log records to the local store.

Aspects of the subject disclosure pertain to the technical problem of returning consistent results to read queries from secondary compute nodes. The technical features associated with addressing these problems include employing a secondary compute node to process read queries, wherein the secondary compute node maintains a local store for rapid response. Moreover, the secondary compute node can include functionality to support physical consistency through wait and retry and transactional consistency by way of versioned data elements.

The subject disclosure supports various products and processes that perform, or are configured to perform, various actions regarding consistent database reads. What follows are one or more exemplary systems and methods.

A data access system comprises: a processor coupled to a memory, the processor configured to execute computer-executable instructions stored in the memory that when executed cause the processor to perform the following actions: submitting a request for a page of data to a storage node in response to a read request, wherein the request includes a first log sequence number indicates an update state of a local store of a compute node; receiving, from the storage node in response to the request, the page of data and a second log sequence number that indicates an update state of the page; waiting until the first log sequence number is greater than or equal to the second log sequence number, wherein the first log sequence number is updated in response to automatic updates of the local store; retrieving a row of data from the page of data in accordance with the read request; and returning a response to the read request that includes the row of data. In one instance, receipt of the page of data from the storage node is delayed until the storage node reaches a third log sequence number that is greater than or equal to the first log sequence number. The system further comprises locating the page that includes the row of data, and, in one case, locating the page comprises navigating a hierarchical structure from a root node. The system further comprises recording a read request timestamp capturing a start time of read request processing and determining whether a data element version timestamp is before or after the read request timestamp. Furthermore, the system comprises continuously locating a prior data element version if the data element version timestamp is after the read request timestamp until the data element version timestamp is before or equal to the read request timestamp. Further yet, in one case, the compute node of the system is a secondary compute node that processes solely read queries.

A method of data access comprises: submitting a request for a page of data to a storage node in response to a read request, wherein the request includes a first log sequence number that indicates an update state of a local store of a compute node; receiving, from the storage node in response to the request, the page of data and a second log sequence number that indicates an update state of the page; waiting until the first log sequence number is greater than or equal to the second log sequence number, wherein the first log sequence number is updated in response to automatic updates of the local store of the compute node; retrieving a row of data from the page in accordance with the read request; and returning a response to the read request based on the row of data. In one instance, receipt of the second log sequence number is delayed until the storage node reaches an update state with third log sequence number that is greater than or equal to the first log sequence number. The method further comprises locating the page that includes the row of data, and, in one instance, locating the page further comprises navigating a hierarchical structure from a root node. The method further comprises recording a read request timestamp capturing a start time of read request processing and determining whether a row version timestamp is before or after the read request timestamp. The method further comprises continuously locating a prior row version if the row version timestamp is after the read request timestamp until the row version timestamp is before or equal to the read request timestamp. The method further comprises monitoring a transaction log for additional log records and applying the additional log records to the local store of the compute node, wherein the local store includes a copy of one or more previously read pages.

A data access method comprises: submitting a request for a page of data to a storage node in response to a read request, wherein the request comprises a page identifier and a first log sequence number that specifies latest update state of a local store of a compute node in terms of application of transaction log records; receiving, from the storage node in response to the request, the page of data and a second log sequence number that indicates an update state of the page of data in terms of application of the transaction log records; waiting until the first log sequence number is greater than or equal to the second log sequence number, wherein the first log sequence number is updated in response to automatic application of the transaction log records to the local store; and retrieving a row of data from the page of data in accordance with the read request. The method further comprises re-traversing a B-tree data structure to locate a page of data comprising the row of data after the waiting. The method also comprises determining whether a row version timestamp is before or after a read request timestamp that captures a start time of read request processing. The method further comprises continuously locating a prior row version if a row timestamp is after the read request timestamp until the row version timestamp is before or equal to the read request timestamp.

As used herein, the terms “component” and “system,” as well as various forms thereof (e.g., components, systems, sub-systems . . . ) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The conjunction “or” as used in this description and appended claims is intended to mean an inclusive “or” rather than an exclusive “or,” unless otherwise specified or clear from context. In other words, “'X′ or ‘Y’” is intended to mean any inclusive permutations of “X” and “Y.” For example, if “‘A’ employs ‘X,’” “‘A employs ‘Y,’” or “‘A’ employs both ‘X’ and ‘Y,’” then “‘A’ employs ‘X’ or ‘Y’” is satisfied under any of the foregoing instances.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

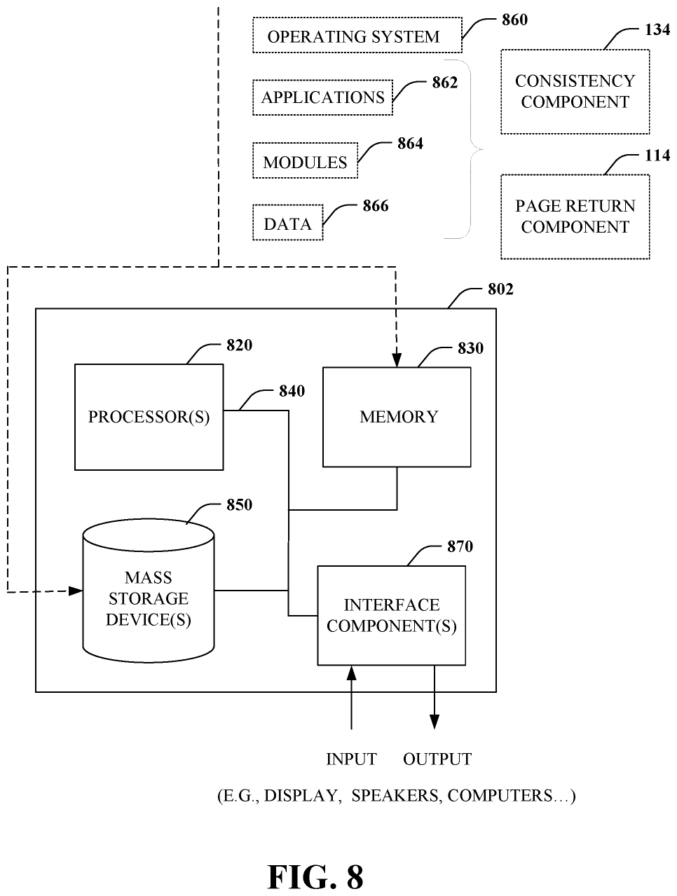

In order to provide a context for the disclosed subject matter, FIG. 8 as well as the following discussion are intended to provide a brief, general description of a suitable environment in which various aspects of the disclosed subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), smart phone, tablet, watch . . . ), microprocessor-based or programmable consumer or industrial electronics, and the like. Aspects can also be practiced in distributed computing environments where tasks are performed by remote processing devices that are linked through a communications network. However, some, if not all aspects, of the disclosed subject matter can be practiced on stand-alone computers. In a distributed computing environment, program modules may be located in one or both of local and remote memory devices.

With reference to FIG. 8, illustrated is an example general-purpose computer or computing device 802 (e.g., desktop, laptop, tablet, watch, server, hand-held, programmable consumer or industrial electronics, set-top box, game system, compute node . . . ). The computer 802 includes one or more processor(s) 820, memory 830, system bus 840, mass storage device(s) 850, and one or more interface components 870. The system bus 840 communicatively couples at least the above system constituents. However, it is to be appreciated that in its simplest form the computer 802 can include one or more processors 820 coupled to memory 830 that execute various computer executable actions, instructions, and or components stored in memory 830.

The processor(s) 820 can be implemented with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 820 may also be implemented as a combination of computing devices, for example a combination of a DSP and a microprocessor, a plurality of microprocessors, multi-core processors, one or more microprocessors in conjunction with a DSP core, or any other such configuration. In one embodiment, the processor(s) 820 can be a graphics processor.

The computer 802 can include or otherwise interact with a variety of computer-readable media to facilitate control of the computer 802 to implement one or more aspects of the disclosed subject matter. The computer-readable media can be any available media that can be accessed by the computer 802 and includes volatile and nonvolatile media, and removable and non-removable media. Computer-readable media can comprise two distinct and mutually exclusive types, namely computer storage media and communication media.

Computer storage media includes volatile and nonvolatile, removable and non-removable media implemented in any method or technology for storage of information such as computer-readable instructions, data structures, program modules, or other data. Computer storage media includes storage devices such as memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other like mediums that store, as opposed to transmit or communicate, the desired information accessible by the computer 802. Accordingly, computer storage media excludes modulated data signals as well as that described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Memory 830 and mass storage device(s) 850 are examples of computer-readable storage media. Depending on the exact configuration and type of computing device, memory 830 may be volatile (e.g., RAM), non-volatile (e.g., ROM, flash memory . . . ) or some combination of the two. By way of example, the basic input/output system (BIOS), including basic routines to transfer information between elements within the computer 802, such as during start-up, can be stored in nonvolatile memory, while volatile memory can act as external cache memory to facilitate processing by the processor(s) 820, among other things.

Mass storage device(s) 850 includes removable/non-removable, volatile/non-volatile computer storage media for storage of large amounts of data relative to the memory 830. For example, mass storage device(s) 850 includes, but is not limited to, one or more devices such as a magnetic or optical disk drive, floppy disk drive, flash memory, solid-state drive, or memory stick.

Memory 830 and mass storage device(s) 850 can include, or have stored therein, operating system 860, one or more applications 862, one or more program modules 864, and data 866. The operating system 860 acts to control and allocate resources of the computer 802. Applications 862 include one or both of system and application software and can exploit management of resources by the operating system 860 through program modules 864 and data 866 stored in memory 830 and/or mass storage device(s) 850 to perform one or more actions. Accordingly, applications 862 can turn a general-purpose computer 802 into a specialized machine in accordance with the logic provided thereby.

All or portions of the disclosed subject matter can be implemented using standard programming and/or engineering techniques to produce software, firmware, hardware, or any combination thereof to control a computer to realize the disclosed functionality. By way of example and not limitation, the consistency component 134 and page return component 114, or other portions of system 100, can be, or form part, of an application 862, and include one or more program modules 864 and data 866 stored in memory and/or mass storage device(s) 850 whose functionality can be realized when executed by one or more processor(s) 820.

In accordance with one particular embodiment, the processor(s) 820 can correspond to a system on a chip (SOC) or like architecture including, or in other words integrating, both hardware and software on a single integrated circuit substrate. Here, the processor(s) 820 can include one or more processors as well as memory at least similar to processor(s) 820 and memory 830, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the consistency component 134 and page return component 114 and/or functionality associated with system 100 can be embedded within hardware in a SOC architecture.

The computer 802 also includes one or more interface components 870 that are communicatively coupled to the system bus 840 and facilitate interaction with the computer 802. By way of example, the interface component 870 can be a port (e.g. serial, parallel, PCMCIA, USB, FireWire . . . ) or an interface card (e.g., sound, video . . . ) or the like. In one example implementation, the interface component 870 can be embodied as a user input/output interface to enable a user to enter commands and information into the computer 802, for instance by way of one or more gestures or voice input, through one or more input devices (e.g., pointing device such as a mouse, trackball, stylus, touch pad, keyboard, microphone, joystick, game pad, satellite dish, scanner, camera, other computer . . . ). In another example implementation, the interface component 870 can be embodied as an output peripheral interface to supply output to displays (e.g., LCD, LED, plasma, organic light-emitting diode display (OLED) . . . ), speakers, printers, and/or other computers, among other things. Still further yet, the interface component 870 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A data access system, comprising:
a processor coupled to a memory, the processor configured to execute computer-executable instructions stored in the memory that when executed cause the processor to perform the following actions:
submitting a request for a page of data to a storage node in response to a read request, wherein the request includes a first log sequence number that indicates an update state of a local store of a compute node;
receiving, from the storage node in response to the request, the page of data and a second log sequence number that indicates an update state of the page;
waiting until the first log sequence number is greater than or equal to the second log sequence number, wherein the first log sequence number is updated in response to automatic updates of the local store;
retrieving a row of data from the page of data in accordance with the read request; and
returning a response to the read request that includes the row of data.

2. The system of claim 1, receipt of the page of data from the storage node is delayed until the storage node reaches a third log sequence number that is greater than or equal to the first log sequence number.

3. The system of claim 1, further comprising locating the page that includes the row of data.

4. The system of claim 3, locating the page comprises navigating a hierarchical structure from a root node.

5. The system of claim 1, further comprising recording a read request timestamp capturing a start time of read request processing.

6. The system of claim 5, further comprising determining whether a data element version timestamp is before or after the read request timestamp.

7. The system of claim 6, further comprising continuously locating a prior data element version if the data element version timestamp is after the read request timestamp until the data element version timestamp is before or equal to the read request timestamp.

8. The system of claim 1, the compute node is a secondary compute node that processes solely read queries.

9. A method of data access, comprising:
submitting a request for a page of data to a storage node in response to a read request, wherein the request includes a first log sequence number that indicates an update state of a local store of a compute node;
receiving, from the storage node in response to the request, the page of data and a second log sequence number that indicates an update state of the page;
waiting until the first log sequence number is greater than or equal to the second log sequence number, wherein the first log sequence number is updated in response to automatic updates of the local store of the compute node;
retrieving a row of data from the page in accordance with the read request; and
returning a response to the read request based on the row of data.

10. The method of claim 9, receipt of the second log sequence number is delayed until the storage node reaches an update state with third log sequence number that is greater than or equal to the first log sequence number.

11. The method of claim 9, further comprising locating the page that includes the row of data.

12. The method of claim 11, locating the page further comprising navigating a hierarchical structure from a root node.

13. The method of claim 9, further comprising recording a read request timestamp capturing a start time of read request processing.

14. The method of claim 13, further comprising determining whether a row version timestamp is before or after the read request timestamp.

15. The method of claim 14, further comprising continuously locating a prior row version if the row version timestamp is after the read request timestamp until the row version timestamp is before or equal to the read request timestamp.

16. The method of claim 9, further comprising monitoring a transaction log for additional log records and applying the additional log records to the local store of the compute node, wherein the local store includes a copy of one or more previously read pages.

17. A data access method, comprising:
submitting a request for a page of data to a storage node in response to a read request, wherein the request comprises a page identifier and a first log sequence number that specifies latest update state of a local store of secondary compute node, that processes read queries, in terms of application of transaction log records;
receiving, from the storage node in response to the request, the page of data and a second log sequence number that indicates an update state of the page of data in terms of application of the transaction log records;
waiting until the first log sequence number is greater than or equal to the second log sequence number, wherein the first log sequence number is updated in response to automatic application of the transaction log records to the local store;
retrieving a row of data from the page of data in accordance with the read request; and
returning a response to the read request based on the row of data.

18. The method of claim 17, further comprising re-traversing a B-tree data structure to locate a page of data comprising the row of data after the waiting.

19. The method of claim 17, further comprising determining whether a row version timestamp is before or after a read request timestamp that captures a start time of read request processing.

20. The method of claim 19, further comprising continuously locating a prior row version if a row timestamp is after the read request timestamp until the row version timestamp is before or equal to the read request timestamp.
